(19) United States
(12) Patent Application Publication
(10) Pub. No.: US 2018/0206522 A1
(43) Pub. Date: Jul. 26, 2018

(54) ICE CREAM CONE WITH INTEGRATED EDIBLE DRIP COLLECTOR

(71) Applicant: Shane Keane, Arlington, VA (US)

(72) Inventor: Shane Keane, Arlington, VA (US)

(21) Appl. No.: 15/416,786

(22) Filed: Jan. 26, 2017

(51) Int. Cl. A23G 9/48

(52) U.S. Cl. CPC A23G 9/48

(57) ABSTRACT

Some embodiments pertain to an ice cream cone having a body and an integrated drip collector. In some embodiments, the body extends radially outwardly from a center axis of the ice cream cone. In some embodiments, the body includes an upper section defining an aperture, a lower section having a bottom, and a wall portion. In some embodiments, the wall portion extends from the lower section to the upper section and defines a reservoir configured to store ice cream within the body. In some embodiments, the ice cream cone further includes a drip collector that is a protrusion of the ice cream cone. In some embodiments, the protrusion includes a trough and an outer edge. In some embodiments, the outer edge extends radially outward from the body and is disposed below a top of the upper section of the body. In some embodiments, the drip collector is configured to receive melted ice cream and to prevent melted ice cream from contacting a hand of a user holding the ice cream cone.

### BACKGROUND

### Field

The present disclosure relates generally to the structure of an ice cream cone and more particularly to an ice cream cone having an integrated, edible drip collector for preventing melting ice cream from reaching a hand of a user.

### Description of Certain Related Art

Ice cream cones are used as holders for ice cream (or other frozen dessert items, such as, custard, yogurt, sorbet, gelato, other frozen confections, etc.) that can be grasped in the hand allowing the ice cream and the ice cream cone to be eaten. Ice cream cones can allow the user to consume the food item without a bowl or spoon.

### SUMMARY OF CERTAIN FEATURES

Some embodiments described herein pertain to ice cream cones having an integrated drip collector. In some embodiments, the drip collector is configured to prevent ice cream (e.g., that has melted, that is dripping, or that is falling) from reaching the holder's hands. In some embodiments, the ice cream cones described herein allow the user to consume the ice cream (or other frozen treat) without the ice cream contacting the user (thereby avoiding sticky or messy hands, stains on clothing, etc.). Accordingly, in some embodiments, the ice cream cones described herein address and solve certain problems encountered when consuming ice cream, (e.g., preventing a user's hand or clothes from becoming messy or sticky due to melting ice cream).

In some embodiments, the ice cream cone comprises a body. In some embodiments, the body extends radially outwardly from a center axis of the ice cream cone. In some embodiments, the body includes a lower section defining a bottom. In some embodiments, the bottom is sealed (or substantially sealed) and configured to contain the ice cream. In some embodiments, the body comprises an upper section defining a reservoir. In some embodiments, the reservoir is configured to hold ice cream within the body.

In some embodiments, the ice cream cone comprises a receiving section supported by the body. In some embodiments, the receiving section connects to the body via the upper section of the body. In some embodiments, the receiving section is disposed or flares radially outwardly from the body. In some embodiments, the receiving section includes a wall portion extending from a lower portion of the receiving section to an upper portion of the receiving section. In some embodiments, the wall portion defines an aperture of the receiving section. In some embodiments, the receiving section is configured to allow ice cream to pass through the receiving section via the aperture and into the body. In some embodiments, the aperture of the receiving section is aligned with the reservoir of the body.

In some embodiments, the upper portion of the receiving section comprises a lip. In some embodiments, the lip extends radially outwardly from the aperture. In some embodiments, the lip forms a circumference of the upper portion of the receiving section and is configured to receive ice cream (e.g., from a scoop, spoon, etc.).

In some embodiments, the ice cream cone comprises a drip collector. In some embodiments, the drip collector is a protrusion extending outwardly from an outer side of the body or receiving section. In some embodiments, the protrusion forms a trough. In some embodiments, the drip collector forms an outermost edge of the ice cream cone. In some embodiments, the outer edge extends radially outward from the body.

In some embodiments, the drip collector is disposed below the upper lip of the receiving section. In some embodiments, the drip collector is disposed closer to the body than to the lip. In some embodiments, the drip collector is configured to receive melted ice cream. In some embodiments, the drip collector is configured to prevent melted ice cream from contacting a hand of a user holding the ice cream cone.

In some embodiments, the ice cream cone comprises a plurality of ribs. In some embodiments, the ribs can be disposed on one or more of an interior of the body, an interior of the receiving section, an interior of the lip (e.g., between the outer periphery of the lip and the aperture of the receiving section), and/or an interior of the drip collector (e.g., extending between the outer periphery of the drip collector and outer wall of the receiving section or body of the cone). In some embodiments, the ribs can be circumferentially spaced apart. In some embodiments, the ribs can be configured to provide strength to the ice cream cone without substantially limiting storage capacity of the aperture and/or reservoir.

In some embodiments, the cone is stackable with one or more other cones. In some embodiments, a plurality of cones can be stacked by placing the body of one cone into a receiving section of another cone. In some embodiments, when a first cone is stacked on top of (or into) a second cone, the drip collector of the first cone rests on top of the lip of the second cone. In some embodiments, the bottom of the drip collector is partially indented such that when a first cone is stacked on to a second cone, the lip of the second cone fits into the indent of the drip collector of the first cone.

In some embodiments, the drip collector projects radially from the body. In some embodiments, the drip collector projects radially from the receiving section. In some embodiments, the ice cream cone can have a body sized to be grasped by a hand of a user.

In some embodiments, the outer edge of the drip collector extends radially at least about 0.5 to about 1.5 centimeter past the outermost periphery (e.g., the edge) of the receiving section (e.g., the lip). In some embodiments, the drip collector is disposed below the upper lip such that when ice cream is received by the receiving section, ice cream is not received by the drip collector.

In some embodiments, the ice cream cone comprises edible ingredients. In some embodiments, the entire ice cream cone is edible. In some embodiments, the drip collector is unitary with the ice cream cone and is also edible. In some embodiments, the ice cream cone is a cake cone and/or sugar cone material.

In some embodiments, a method of making any one or more of the above cones is contemplated. In some embodiments, the method includes preparing ice cream cone batter. In some embodiments, the batter is placed into a mold. In some embodiments, the mold includes one or more features that allow the batter to define the drip collector. In some embodiments, the mold can be cooked to solidify the batter forming the cone. In some embodiments, the mold can be removed to reveal an ice cream cone with a drip collector that is a single, unitary structure. In some embodiments the unitary structure is completely edible. In some embodiments, the edible drip collector is fused to the cone and is molded or shaped separately from the body of the cone.

In some embodiments, the body is substantially cylindrical. In some embodiments, the body is substantially conical. In some embodiments, the receiving section is substantially bell-shaped. In some embodiments, the body and/or the receiving section has angular features (e.g., a shape that is open, cubical, rectangular, tetrahedral, pyramidal, etc.) that define the body and/or the receiving section.

In other embodiments, the ice cream cone includes a body extending radially outwardly from a center axis of the ice cream cone. In some embodiments, the body includes an upper section defining an aperture, a lower section having a bottom, and a wall portion. The wall portion extends from the lower section to the upper section and defines a reservoir configured to store ice cream within the body. In some embodiments, the ice cream cone further includes a drip collector that is a protrusion of the ice cream cone. In some embodiments, the protrusion includes a trough and an outer edge. In some embodiments, the outer edge extends radially outward from the body and is disposed below a top of the upper section of the body. In some embodiments, the drip collector is configured to receive melted ice cream and to prevent melted ice cream from contacting a hand of a user holding the ice cream cone.

Any of the features, components, or details of any of the arrangements or embodiments disclosed in this application, including without limitation any of the ice cream cone embodiments disclosed above or below, are interchangeably combinable with any other features, components, or details of any of the arrangements or embodiments disclosed herein to form new arrangements and embodiments.

For purposes of summarizing the disclosure, certain aspects, advantages and novel features of the inventions have been described herein. It is to be understood that not necessarily all such advantages can be achieved in accordance with any particular embodiment of the inventions disclosed herein. Thus, the inventions disclosed herein can be embodied or carried out in a manner that achieves or optimizes one advantage or group of advantages as taught herein without necessarily achieving other advantages as can be taught or suggested herein.

### BRIEF DESCRIPTION OF THE DRAWINGS

Various embodiments are depicted in the accompanying drawings for illustrative purposes, and should in no way be interpreted as limiting the scope of the embodiments.

FIG. 1A illustrates a side view of an embodiment of an ice cream cone.

FIG. 1B illustrates a top view of the ice cream cone of FIG. 1A.

FIG. 2 illustrates a plurality of stacked ice cream cones according to some embodiments.

FIG. 3 illustrates a side view of an ice cream cone according to some embodiments.

### DETAILED DESCRIPTION

A variety of methods and edible holders for frozen desserts are described herein. These methods and holders may be employed to achieve one or more desired improvements. The methods and holders described are non-limiting examples and are not intended to restrict the general concepts presented and the various aspects and features of these concepts. Furthermore, the phraseology and terminology used herein is for the purpose of description and should not be regarded as limiting. For example, although various embodiments are described in connection with the term “ice cream,” that term is illustrative only and is intended to be just one type of frozen (meltable) food that is used with the devices and the methods disclosed herein. Thus, in places where the term ice cream is used in the disclosure herein, that term is intended to encompass other foods (e.g., desserts and/or frozen dessert items, such as, frozen custard, frozen yogurt, sorbet, gelato, other frozen confections, etc.). No features, structure, or step disclosed herein is essential or indispensable.

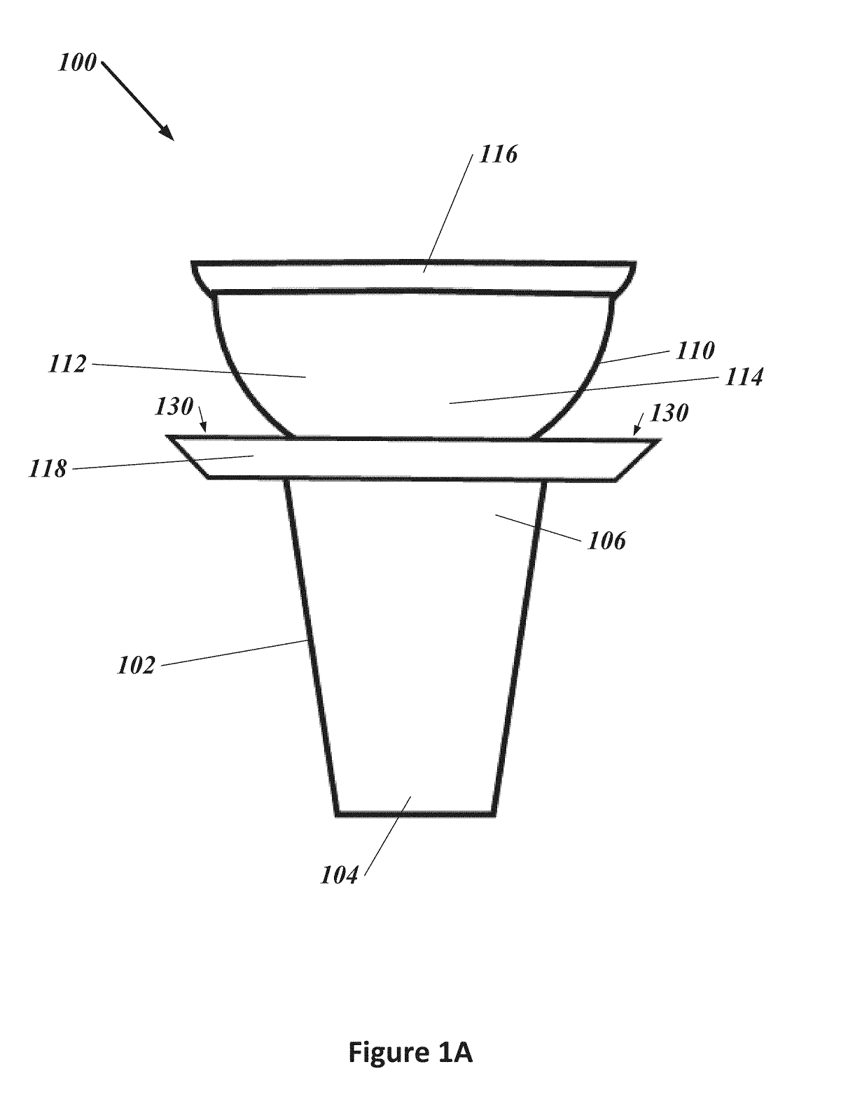

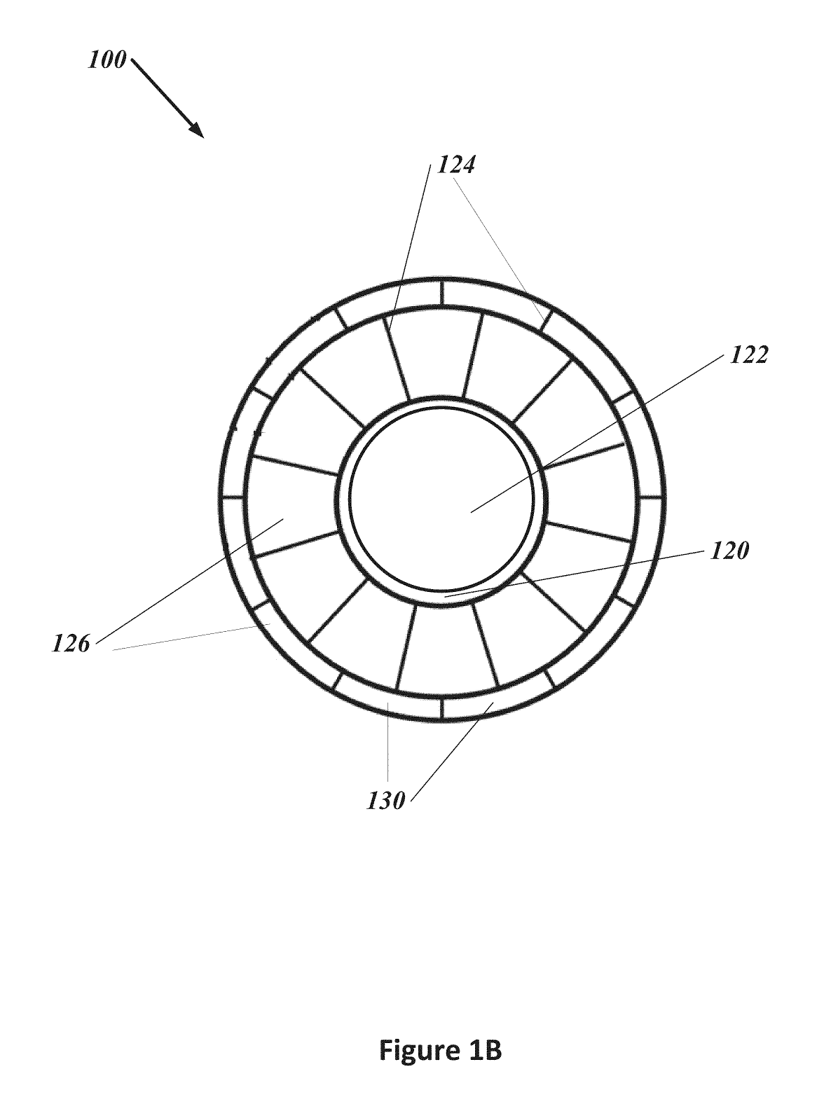

FIG. 1A illustrates an ice cream cone 100 according to some embodiments. As depicted, the ice cream cone 100 includes a body 102, a drip collector 118, and a receiving section 114. Ice cream or other frozen desserts can be placed in the ice cream cone 100 via the receiving section 114. In some embodiments, the drip collector 118 prevents melted ice cream from dripping down the outside of the receiving section 110 and reaching a hand of a user that is holding the body 102 of the ice cream cone 100.

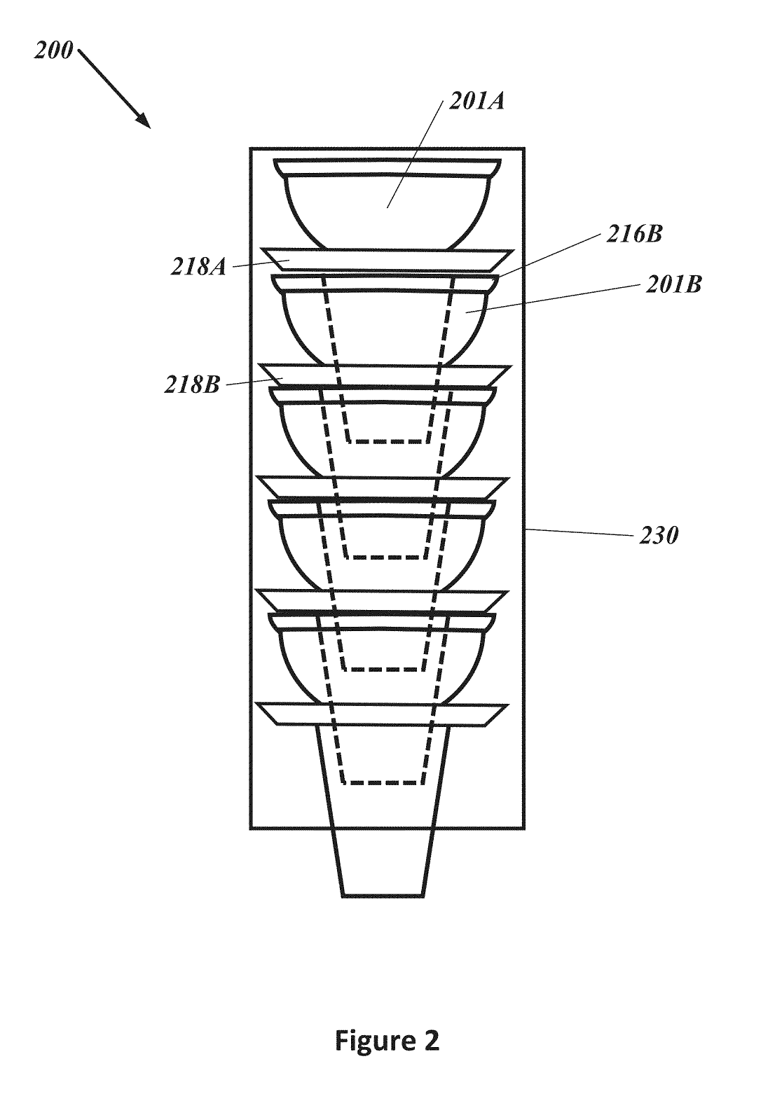

In some embodiments, the body 104 extends radially outwardly from a center axis of the ice cream cone (axis not shown). In some embodiments, as demonstrated by in FIGS. 1 and 2, the body can have a generally cylindrical shape. In some embodiments, as shown in FIG. 1A, the upper portion 106 of the body 102 can have a slightly larger circumference than the bottom 104 of the body 102, thereby aiding ice cream inserted into the receiving section to slide from the upper portion 106 to the bottom 104 of the body 102. In some embodiments, this configuration can also be described as a conical-shape having a flat or substantially flat bottom (instead of a pointed bottom, e.g., a conical frustrum). In some embodiments, the flat or substantially flat bottom can advantageously enable the ice cream cone 100 to stand upright on a surface without support. In some embodiments, the upper portion of the body can have the same circumference of the bottom of the body (not shown).

In some embodiments, the cone can have a generally cylindrical shape where the upper portion 106 of the body 102 has a slightly smaller circumference than the bottom 104 of the body 102. Having a larger bottom 104 allows the cone 102 to advantageously (and to the enjoyment of the consumer) have more ice cream stored at the bottom 104 of the ice cream cone 100 when the consumer is nearing the end of the cone 102. In some embodiments, the larger bottom 104 (as compared to the upper portion 106) can also provide better support to a cone 102, thereby greater enabling it to stand upright on a surface without support.

In some embodiments, the body 104 can have a substantially conical shape or any other appropriate shape. In some embodiments, as described elsewhere herein, the body 104 extends radially outwardly from a center axis of the ice cream cone. In some embodiments, the center axis may be defined as the vertical axis when the cone 100 is upright. In some embodiments, the center axis of the cone 100 may be an axis other than the vertical axis.

For purposes of this disclosure, extending radially outward can mean extending perpendicularly or at some angle other than 90 degrees. In addition, extending radially outward can mean extending outwardly, evenly or unevenly, to form a circular, semi-circular, square, rectangular, or textured profile or any other shape. As such, in some embodiments, the body 102, drip collector 118, receiving section 110, and/or cone 100 can be symmetrical or asymmetrical with respect to the center axis of the ice cream cone 100.

As shown in FIG. 1A, in some embodiments, the body 102 includes a lower section 104 having a bottom and an upper section 106 defining a reservoir (as shown in FIG. 1B). As described below with respect to FIG. 1B, the reservoir is configured to store ice cream within the body 102.

In some embodiments, the body 102 is sized to be grasped by a hand of a user. In some embodiments, the body 102 can be sized to be grasped by two hands of a user or multiple users. In some embodiments, the body 102 can have a generally smooth or flat outer surface or alternatively can have a rigid surface (for example, waffle-like surface). In some embodiments, the diameter of the bottom of the body of the cone is greater than or equal to about 0.75 inches, about 1 inch, about 1.5 inches, or values ranging between the aforementioned values. In some embodiments, the largest diameter of the ice cream cone body is greater than or equal to about 1.0 inches, about 1.5 inches, about 2.0 inches, about 2.5 inches, or values ranging between the aforementioned values.

In some embodiments, the ice cream cone 100 also includes a receiving section 110 supported by the body 102. In some embodiments, the receiving section 110 is disposed radially outward from the body 102 (for example, the receiving section 110 is broader than the body). In some embodiments, the receiving section 110 is narrower than the body 102. In some embodiments, the receiving section 110 is partly broader than the body 102, partly narrower than the body 102, and/or partly about the same width as the body 102. For example, the receiving section can have a winding, rippled, or folded shape.

In some embodiments, where the receiving section 110 is disposed radially outward from the body of the cone, the diameter of the receiving section 110 and the body 102 are at a ratio at least about 1:1, about 1.5:1, about 2:1, ratios ranging between the aforementioned ratios or otherwise. In some embodiments, the outer circumference of the receiving section 110 extends radially outwardly from an outer surface of the body 102 a distance greater than or equal to about 0.25 inches, about 0.5 inches, about 1.0 inches, or values ranging between the aforementioned values.

In some embodiments, the receiving section 110 includes a wall portion 112 extending from a lower portion 114 of the receiving section to an upper lip 116 of the receiving section. In some embodiments, the wall portion 112 defines an aperture (as shown in FIG. 1B) of the receiving section 110.

In some embodiments, the receiving section 110 can have an inverted bell-shaped (as shown in FIG. 1A). In some embodiments, the bell-shape advantageously provides an ice cream provider (for example, the one adding ice cream to the cone) with a broad region in which to insert the ice cream. In some embodiments, as described above with respect to the body 102, the receiving section 110 can have a generally cylindrical shape. In some embodiments, the receiving section 110 can have a winding or folded shape.

In some embodiments, as shown in FIG. 1A, the ice cream cone 100 comprises a drip collector 118. In some embodiments, the drip collector 118 is configured to receive melted ice cream. In some embodiments, the drip collector 188 is configured to prevent melted ice cream from contacting a hand or clothing of a user holding the ice cream cone. As shown in FIG. 1A, in some embodiments, the drip collector 118 is a protrusion of the ice cream cone 100. In some embodiments, the drip collector 118 and the rest of the ice cream cone are a single piece (e.g., are unitary, integral, fused, etc.).

In some embodiments, the drip collector 118 and the rest of the ice cream cone are manufactured by injection molding of batter into a mold that comprises at least a body and a drip collector molding feature. In some embodiments, a method of making the ice cream cone includes preparing ice cream cone batter and placing the batter is placed into a mold. In some embodiments, the mold includes one or more features that allow the batter to define the drip collector. In some embodiments the method of making the ice cream cone includes cooking, baking, or otherwise providing heat to the mold and/or the batter to solidify the batter, thereby forming the cone. In some embodiments the method can include removing the mold to reveal an ice cream cone with a drip collector that is a single, unitary structure. In some embodiments the unitary structure is completely edible. In some embodiments, the edible drip collector is fused to the cone and is molded or shaped separately from the body of the cone.

In some embodiments, the entire ice cream cone 100 (e.g., the body 102, the receiving section 110, and the drip collector 118) are fully integrated together and are a single unitary piece (i.e., individual elements cannot be removed beyond breaking a piece of the cone). In some embodiments, unlike a slip-on sleeve which is not integrated into a cone and therefore not entirely flush with the sides of the cone (e.g., because of cone imperfections), the fully integrated (e.g., unitary) drip collector 118 advantageously prevents ice cream drips from running down the side of the cone beyond and past the drip collector (such as may be possible with a slip-on sleeve).

In some embodiments, the drip collector 118 (i.e., the protrusion of the cone 100) forms a trough and an outer edge. In some embodiments, the drip collector 118 can be a protrusion from the body 102, a protrusion from the receiving section 110, or a protrusion from the area in which the body 102 and the receiving section 110 meet. In some embodiments, the drip collector 118 is positioned proximate the upper lip 116 of the receiving section 110. In some embodiments, the drip collector 118 is positioned at a location below the upper lip 116. In some embodiments, the drip collector 118 may advantageously be positioned sufficiently below the upper lip 116 so that ice cream is not placed within the drip collector when the ice cream cone is being filled. In some embodiments, this placement discourages ice cream dispensers from placing ice cream on the drip collector 118 as an additional “plate” for the ice cream, which would ultimately detract from the drip collector's purpose of catching melting ice cream. In some embodiments, the drip collector 118 is located below the upper lip 116 by a distance of greater than or equal to about 0.5 inches, about 0.75 inch, about 1.0 inches, or values between the aforementioned values. In some embodiments, the drip collector 118 is located below the upper lip 116 by a distance of less than or equal to about 0.5 inches, about 0.75 inch, about 1.0 inches, or values between the aforementioned values.

In some embodiments, the outer edge of the drip collector 118 extends radially outward from the center axis of the cone 100. As described above with respect to the body 102, radially outward can be any extension from the cone, symmetrically, asymmetrically, evenly, unevenly, and at any angle. Thus, in some embodiments, the drip collector can have a generally circular shape, a winding or folded shape, or any other shape that does not substantially detract from its overall effectiveness in preventing melted ice cream from reaching a hand of a user.

In some embodiments, as depicted in FIG. 1A, the outer edge of the drip collector 118 extends radially past the upper lip 116 of the receiving section 110. In some embodiments, the drip collector can be wider than the upper lip 116 of the receiving section 110 which can advantageously allow the drip collector 116 to catch any ice cream which falls down directly from the upper lip 116. For instance, the drip collector 118 can extend past the outer edge approximately 0.2, 0.4, 0.6, 0.8, 1, 1.2, 1.4, 1.6. 1.8 or 2 centimeters (+/−5 or 10 millimeters). In other examples, the drip collector 116 can extend past the outer edge within a range (for instance, 0.2 to 2 cm, 0.5 to 1.5 cm, 0.8 to 1.2 cm.). In some embodiments, the outer periphery of the drip collector (for example, the edge or lip of the drip collector) extends outwardly from the outer periphery of the receiving section (or the body) by at least about 0.25 inches, about 0.5 inch, about 0.75 inches, or values ranging between the aforementioned values. In some embodiments, the outer periphery of the drip collector (e.g., the edge or lip of the drip collector) extends outwardly from the outer periphery of the receiving section (or the body) by equal to or less than about 0.25 inches, about 0.5 inch, about 0.75 inches, or values between the aforementioned values.

Alternatively, the drip collector 118 can be narrower than the upper lip 116 which can advantageously provide for a smaller ice cream cone 100 while still preventing melting ice cream from running down the sides of the receiving section 110 and/or the body 102 and reaching a hand of a user. In other words, in embodiments where the ice cream cone is conical or has an ice cream aperture that extends outwardly from the location of the drip collector 118, the drip collector 118 can extend outwardly from the body 102 or receiving section 110, but not outwardly from the outermost periphery of the cone itself. For instance, the drip collector 118 can be approximately 0.2, 0.4, 0.6, 0.8, 1, 1.2, 1.4, 1.6. 1.8 or 2 centimeters (+/−a 5 or 10 millimeters) inset from the upper lip 116 of the receiving section 110. In some embodiments, the outer periphery of the drip collector (for example, the edge or lip of the drip collector 118) is set inwardly from the outer periphery of the receiving section (or the body) by at least about 0.25 inches, about 0.5 inch, about 0.75 inches, or values ranging between the aforementioned values. In some embodiments, the outer periphery of the drip collector 118 (for example, the edge or lip of the drip collector 118) is set inwardly from the outer periphery of the receiving section (or the body 102) by equal to or less than about 0.25 inches, about 0.5 inch, about 0.75 inches, or values ranging between the aforementioned values.

In some embodiments, the drip collector 118 forms a trough (e.g., a container, a basin, a catch-reservoir, etc.) which acts as a barrier for the melted ice cream. In some embodiments, the trough acts a basin for the melted ice cream (e.g., holding or containing it there for consumption by the user). In some embodiments, the trough is relatively shallow such that the drip collector 118 is substantially flat. In some embodiments, the trough deep enough to store all melted ice cream accumulated while a user is eating. In some embodiments, the trough has a depth (i.e., the distance below the outer edge) of at least about 5 mm, about 10 mm, about 20 mm, about 30 mm, or values ranging between the aforementioned values. In other examples, the trough has a depth (i.e., the distance below the outer edge) of at greater than or equal to about 5 mm, about 10 mm, about 20 mm, about 30 mm, or values ranging between the aforementioned values.

In some embodiments, the cone 100 further comprises straw (not shown). In some embodiments, the straw extends upwardly from the bottom of the trough (or the bottom of the body) and is configured to allow a user to drink any melted ice cream which has accumulated in the trough (or at the bottom of the body). In some embodiments, the straw is edible.

In some embodiments, the whole ice cream cone 100, including, for instance, the drip collector 118, is edible and can include one or more of any suitable ingredients. For instance, the cone may include cake cone, sugar cone, candy cone, chocolate, and/or other ingredients. The ice cream cone can be manufactured by inserting batter into a mold (e.g., a cake-cone mold) or onto cooking plates (e.g., plate for waffle cones). In some examples, a plurality of ice cream cone can advantageously be massed-produced using molds.

FIG. 1B illustrates a top view of the ice cream cone 100 of FIG. 1A. As described above, in some embodiments, the wall portion 112 of the receiving section 110 defines an aperture 120. In some embodiments, the body 102 defines a reservoir 122. In some embodiments, as illustrated in FIG. 1B, the aperture 120 is aligned with the reservoir 122 to allow ice cream to pass through the receiving section via the aperture 120 to the reservoir 122 of the body. In some embodiments, the aperture 120 is wider than the reservoir 122, thereby acting as an ice cream funnel from the receiving section 116 to the body 102. In some embodiments, the aperture 120 is the same size or narrower than the reservoir 122.

As depicted in FIG. 1B, in some embodiments, the ice cream cone 100 can include a plurality of ribs 124 disposed on an interior of the ice cream cone 100 (for instance, to provide improved strength to the ice cream cone 100). For instance, in some embodiments, the plurality of ribs 124 can be disposed on an interior of the body 102, an interior of the receiving section 116, and/or an interior of the drip collector 118.

In some embodiments, the plurality of ribs 124 can be circumferentially spaced apart. In other examples, the plurality of ribs 124 can be evenly or unevenly space apart. In some embodiments, the plurality of ribs 124 may only be disposed on a portion of the body 102, receiving section 116, and/or drip collector 118. For instance, in some embodiments, the plurality of ribs 124 may only be disposed on an interior top portion (for example, an interior of the upper lip 116) of the receiving section 110.

In some embodiments, the plurality of ribs defines a plurality of cavities 126 that are configured to accept ice cream. In some embodiments, by defining the plurality of cavities 126, the plurality of ribs 124 advantageously provide strength to the ice cream cone 100 without substantially limiting storage capacity of the aperture 122 and/or the reservoir 120.

FIG. 2 illustrates a plurality of stacked ice cream cones inside a dispensing container 230 according to some embodiments. As illustrated, each ice cream cone is stackable with one or more other cones. For example, a plurality of cones can be stacked by placing the body of one cone into a receiving section of another cone. In some embodiments, when a first cone 201A is stacked on top of (or into) a second cone 201B, the drip collector 218A of the first cone 201A rests on top of the lip 218B of the second cone 201B. As illustrated, additional ice cream cones can be added to the stack using the same technique. Although FIG. 2 illustrates a stack including five ice cream cones, one of ordinary skill would understand the stack can include any number of ice cream cones.

In some embodiments (not shown), the bottom of each drip collector is partially indented (e.g., partially concave) such that when a first cone 201A is stacked on to a second cone 201B, the lip 216B of the second cone 201B fits into the indent of the drip collector 218A of the first cone 201A. In some embodiments, the indent of the drip collector provides further support to stack of cones.

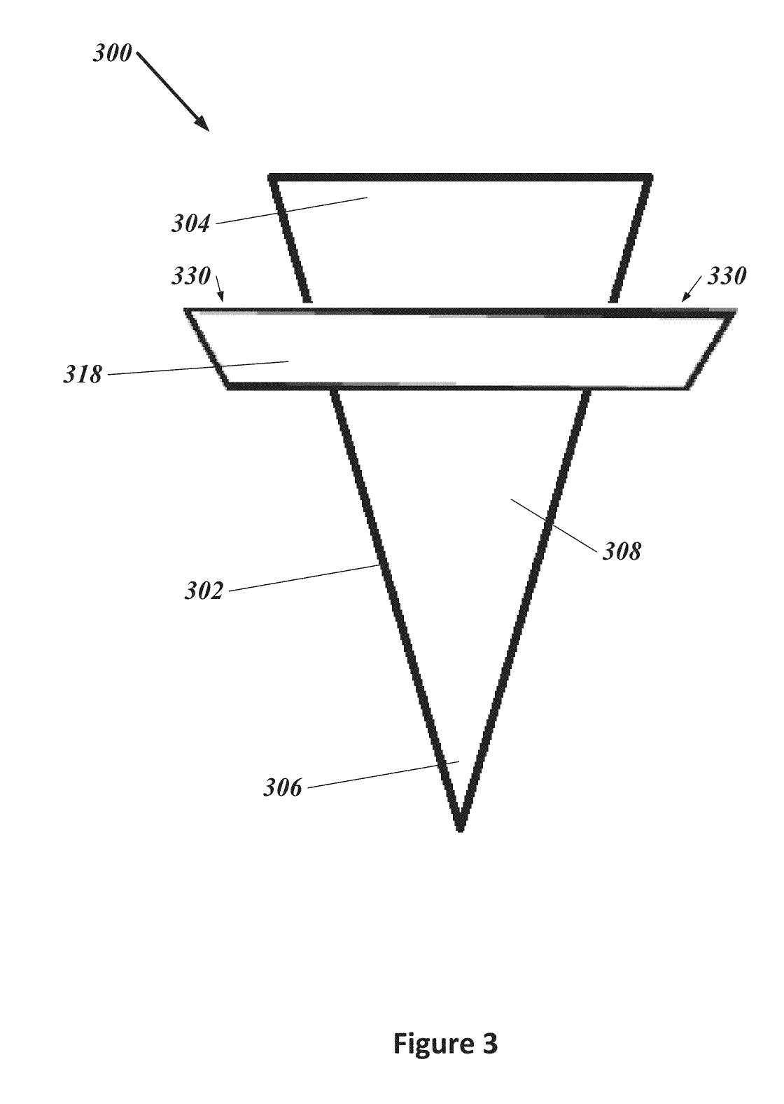

FIG. 3 illustrates an ice cream cone 300 according to some embodiments. As depicted, in some embodiments, the ice cream cone 300 includes a body 302 and a drip collector 318. In some embodiments, the ice cream cone 300 does not include a receiving section. In some embodiments, the receiving section of the cone is the body. Ice cream or other frozen desserts can be placed in the ice cream cone 100 via an aperture (not shown) defined by the body 302.

In some embodiments, as depicted in FIG. 3, the body 302 can have a conical-shape. In some embodiments, as described elsewhere herein, the body 302 can have a variety of other shapes including, but not limited to, a generally cylindrical shape, conical frustrum shape, and the like.

In some embodiments, as described elsewhere herein, the body 302 can extend radially outwardly from a center axis of the ice cream cone 300. In some embodiments, the body 302 can include an upper section 304 defining an aperture (not shown), a lower section 306, and a wall portion 308. In some embodiments, the wall portion 308 can extend from the lower section 306 to the upper section and define a reservoir (not shown) that is configured to store ice cream within the body.

In some embodiments, the body 302 can include an upper lip disposed at the top 304 of the body. In some embodiments, the body 302 is sized to be grasped by a hand of a user. Alternatively, the body 302 can be sized to be grasped by two hands of a user or multiple users. In some embodiments, the body 302 can have a generally smooth or flat outer surface or alternatively can have rigid surface (for example, waffle-like surface).

In some embodiments, as described elsewhere herein, the ice cream cone 300 further includes a drip collector 318 configured to receive melted ice cream and to prevent melted ice cream from contacting a hand of a user holding the ice cream cone. In the embodiment illustrated in FIG. 3, the drip collector 318 is a protrusion of the body 302. In some embodiments, the entire ice cream cone 100 (e.g., the body 302 and the drip collector 318) is fully integrated together and are a single unitary piece (i.e., individual elements cannot be removed beyond breaking a piece of the cone).

In some embodiments, the drip collector 318 forms a trough and an outer edge. In some embodiments, the drip collector 318 is positioned at a location below the top of the upper portion 304 of the body 302. In some embodiments, the drip collector 318 may advantageously protrude from a location on the body 302 below the lip. In some embodiments, the placement of the drip collector below the top of the body advantageously discourages an ice cream dispenser from placing ice cream on the drip collector 318 as an additional “plate” for the ice cream, which would ultimately detract from the purpose of the drip collector 318 (for example, catching melting ice cream).

In some embodiments, the drip collector 318 is located below the upper portion 304 by a distance of greater than or equal to about 0.5 inches, about 0.75 inch, about 1.0 inches, or values between the aforementioned values. In some embodiments, the drip collector 318 is located below the upper portion 304 by a distance of less than or equal to about 0.5 inches, about 0.75 inch, about 1.0 inches, or values between the aforementioned values.

In some embodiments, the outer edge of the drip collector extends radially past the upper lip of body. For instance, the drip collector 118 can extend past the outer edge approximately 0.2, 0.4, 0.6, 0.8, 1, 1.2, 1.4, 1.6. 1.8 or 2 centimeters (+/−5 or 10 millimeters). In other examples, the drip collector 116 can extend past the outer edge within a range (for instance, 0.2 to 2 cm, 0.5 to 1.5 cm, 0.8 to 1.2 cm.).

In some embodiments, the outer periphery of the drip collector (e.g., the edge or lip of the drip collector) extends outwardly from the outer periphery of the body by at least about 0.25 inches, about 0.5 inch, about 0.75 inches, or values ranging between the aforementioned values. In some embodiments, the outer periphery of the drip collector (e.g., the edge or lip of the drip collector) extends outwardly from the outer periphery of the body by equal to or less than about 0.25 inches, about 0.5 inch, about 0.75 inches, or values between the aforementioned values.

As described elsewhere herein with respect to FIG. 1A, in some embodiments, the outer edge of the drip collector 318 extends radially outward from the center axis of the cone 300 and forms a trough. In some embodiments, the trough acts as a barrier for the melted ice cream as well as a basin for the melted ice cream. In some embodiments, the cone 300 further comprises straw (not shown) extending outwardly from the bottom of the trough and configured to allow a user to drink any melted ice cream which has accumulated in the trough.

Any terms generally associated with circles, such as “radius” or “radial” or “diameter” or “circumference” or “circumferential” or any derivatives or similar types of terms are intended to be used to designate any corresponding structure in any type of geometry, not just circular structures. For example, “radial” as applied to another geometric structure should be understood to refer to a direction or distance between a location corresponding to a general geometric center of such structure to a perimeter of such structure; “diameter” as applied to another geometric structure should be understood to refer to a cross sectional width of such structure; and “circumference” as applied to another geometric structure should be understood to refer to a perimeter region. Nothing in this specification or drawings should be interpreted to limit these terms to only circles or circular structures.

1. An ice cream cone, comprising:
a body extending radially outward from a center axis of the ice cream cone, the body comprising:
a lower section comprising a bottom and an upper section defining a reservoir, wherein the reservoir is configured to store ice cream within the body;
a receiving section supported by the body and disposed radially outward from the body, the receiving section comprising:
a wall portion extending from a lower portion of the receiving section to an upper lip of the receiving section and defining an aperture of the receiving section, wherein the aperture is aligned with the reservoir of the body to allow ice cream to pass through the receiving section via the aperture to the body;
a drip collector comprising a protrusion from the receiving section, the protrusion forming a trough and an outer edge, the outer edge extending radially outward from the body and disposed below the upper lip of the receiving section;
wherein the drip collector is configured to receive melted ice cream and to prevent melted ice cream from contacting a hand of a user holding the ice cream cone; and
wherein the drip collector, the body, and the receiving section are a single, unitary structure.

2. The ice cream cone of claim 1, further comprising a plurality of ribs disposed on an interior of the body and/or an interior of the receiving section, wherein the ribs are circumferentially spaced apart and are configured to provide strength to the ice cream cone without substantially limiting storage capacity of the aperture and/or reservoir.

3. The ice cream cone of claim 1, wherein the cone is edible.

4. The ice cream cone of claim 1, wherein the body is substantially cylindrical.

5. The ice cream cone of claim 1, wherein the body is substantially conical.

6. The ice cream cone of claim 1, wherein the receiving section is substantially bell-shaped.

7. The ice cream cone of claim 1, wherein the drip collector projects radially from the body.

8. The ice cream cone of claim 1, wherein the drip collector projects radially from the receiving section.

9. The ice cream cone of claim 1, comprising cake cone and/or sugar cone material.

10. The ice cream cone of claim 1, wherein the outer edge of the drip collector extends radially about 0.5 to 1.5 centimeter past an edge of the upper lip of the receiving section.

11. The ice cream cone of claim 1, wherein the body comprises a shape that is cylindrical, conical, cubical, rectangular, tetrahedral, or pyramidal.

12. The ice cream cone of claim 1, wherein the drip collector is disposed below the upper lip such that when ice cream is received by the receiving section, ice cream is not received by the drip collector.

13. An ice cream cone, comprising:
a body extending radially outward from a center axis of the ice cream cone, the body including an upper section defining an aperture, a lower section having a bottom, and a wall portion, the wall portion extending from the lower section to the upper section and defining a reservoir configured to store ice cream within the body; and
a drip collector protruding from and integrally formed with the body, the drop collector comprising an outer edge that extends radially outward from the body and is disposed below a top of the upper section of the body, wherein the drip collector defines a trough around a portion of the body, the trough being configured to receive melted ice cream and to prevent the melted ice cream from contacting a hand of a user holding the ice cream cone.

14. The ice cream cone of claim 13, further comprising a plurality of ribs disposed on an interior of the body, wherein the ribs are circumferentially spaced apart and are configured to provide strength to the ice cream cone without substantially limiting storage capacity of the reservoir.

15. The ice cream cone of claim 13, comprising edible material.

16. The ice cream cone of claim 15, comprising cake cone and/or sugar cone material.

17. The ice cream cone of claim 13, wherein the body is substantially cylindrical.

18. The ice cream cone of claim 13, wherein the body is substantially conical.

19. The ice cream cone of claim 13, wherein the outer edge of the drip collector extends radially about 0.5 to 1.5 centimeters past the top of the upper section of the body.

20. A method of making the ice cream cone of claim 1, the method comprising:
preparing ice cream cone batter;
placing the ice cream cone batter into a mold, wherein the mold includes one or more features that allow the batter to define the drip collector;
providing heat to the mold and/or the batter to solidify the batter and form the ice cream cone with drip collector;
removing the mold to reveal the ice cream cone with the drip collector, wherein the ice cream cone with the drip collector is a single, unitary structure and is completely edible.
